(19) United States
(12) Patent Application Publication
(10) Pub. No.: US 2014/0034383 A1
(43) Pub. Date: Feb. 6, 2014

(54) WIRE HARNESS

(71) Applicants: Akihiro Hayashi, Yokkaichi (JP); Fujio Sonoda, Yokkaichi (JP)

(72) Inventors: Akihiro Hayashi, Yokkaichi (JP); Fujio Sonoda, Yokkaichi (JP)

(73) Assignees: AUTONETWORKS TECHNOLOGIES, LTD., Yokkaichi, Mie (JP); SUMITOMO ELECTRIC INDUSTRIES, LTD., Osaka-shi, Osaka (JP); SUMITOMO WIRING SYSTEMS, LTD., Yokkaichi-shi, Mie (JP)

(21) Appl. No.: 14/110,675

(22) PCT Filed: Apr. 5, 2012
(86) PCT No.: PCT/JP2012/059368

§ 371 Date: Oct. 8, 2013

(30) Foreign Application Priority Data
Apr. 12, 2011 (JP) 2011-088423

(51) Int. Cl. H01B 9/00

(52) U.S. Cl. CPC H01B 9/00
USPC 174/74 R

(57) ABSTRACT

Some embodiments relate to a wire harness capable of constituting a two-phase or three-phase power line having superior heat radiating properties using very versatile round electric wires without requiring extra wires. A wire harness includes round electric wires, crimp terminals, a shield member, and a corrugated tube. The shield member and the corrugated tube cover the periphery of an electric wire bundle constituted by the round electric wires, the number of which is a multiple of six. The wire harness has a structure in which each of the crimp terminals is attached to one of a plurality of sub-groups of electric wires obtained by dividing the electric wire bundle into equal parts, each of which includes a plurality of the round electric wires.

### BACKGROUND

Some embodiments relate to a wire harness.

Large electric current flows through related art wire harnesses connecting electric devices that are mounted to electric vehicles, such as hybrid cars or electric cars. Therefore, a core wire, that is a conductor and has relatively large cross-sectional area, is used for a coated electric wire constituting the wire harness.

However, as the cross-sectional area of the core wire becomes larger, the coated electric wire becomes harder to bend. Therefore, there are cases where the wire harness is subject to constraints of its installation position in a vehicle. To address or solve this problem, it has been proposed to use an electric wire bundle having an equivalent cross-sectional area as a single coated electric wire, in which a core wire has a large cross-sectional area. The electric wire bundle is secured by tying a plurality of coated electric wires in which a core wire has a small cross-sectional area in a bundle.

JP H05-263376A (JP 376) discloses an electric wire having a structure in which seven insulated thin lines are tied in a bundle. The insulated thin line has a structure in which an insulation coating covers the periphery of a metal conductor.

### SUMMARY

The periphery of the electric wire bundle is covered with an exteriormember (such as a corrugated tube), such that the electric wire bundle is protected. In this case, as the ratio of the void formed between the coated electric wires, and between the coated electric wires and the exterior member, becomes larger within the exterior member, heat radiating properties of the electric wire bundle decreases. Therefore, if a large electric current flows through the electric wire bundle, the temperature of the coated electric wire rises, and then undesirable effects are produced, such as deterioration of the electrical characteristics including an increase in impedance and deterioration of an insulation coating.

On the other hand, if an electric wire that does not have a round shape, and instead has a non-standard shape (such as an electric wire having an angular shape) is adopted, the void ratio within the exterior member can be reduced. However, since the versatility of the electric wire having a non-standard shape is low, it is desirable that a general electric wire having a round shape is adopted with regard to cost and manufacturing man-hours.

Furthermore, generally, a two-phase power line is used to connect a battery and an inverter that are mounted to electric vehicles, and a three-phase power line is used to connect an inverter and a motor or a power generator. However, if the electric wire bundle described in JP 376 is adopted for a two-phase power line or for a three-phase power line, the electric wires included in the electric wire bundle cannot be divided into equal parts and assigned to the respective phases, and thus extra electric wires are present in securing the cross-sectional area of the electric wire that is commonly required for each phase. Accordingly, it is inappropriate to adopt the electric wire bundle described in JP 376 for a two-phase power line or for a three-phase power line.

Some of the embodiments address the problems described above, and thereby provide a two-phase or three-phase power line having superior heat radiating properties using very versatile round electric wires without requiring extra wires.

A wire harness of a first embodiment includes round electric wires, which are electric wires having a round shape covered with an insulation coating. The wire harness includes an electric wire bundle in which a multiple of six of the round electric wires is tied in a bundle, a plurality of terminals provided at both ends of each of a plurality of sub-groups of electric wires, the sub-groups of electric wires being units obtained by dividing the electric wire bundle into equal parts, each unit including a plurality of the round electric wires, and a tubular exterior member which covers a periphery of the electric wire bundle.

In accordance with another second embodiment, the electric wire bundle can be constituted by twelve of the round electric wires, and the electric wire bundle includes a first electric wire group constituted by three of the round electric wires tied in a bundle, such that each of the three round electric wires comes into contact with the adjacent two round electric wires, a second electric wire group constituted by three of the round electric wires arranged at an outer edge of the three round electric wires constituting the first electric wire group, at such positions that three grooves formed between the three round electric wires of the first electric wire group are blocked, and a third electric wire group constituted by six of the round electric wires arranged at an outer edge of the six round electric wires constituting the first electric wire group and the second electric wire group, at such positions that six grooves formed between the six round electric wires of the first electric wire group and the second electric wire group are blocked

In accordance with another third embodiment, the electric wire bundle can be constituted by eighteen of the round electric wires, and the electric wire bundle includes a first electric wire group constituted by three of the round electric wires tied in a bundle, such that each of the three round electric wires comes into contact with the adjacent two round electric wires, a second electric wire group constituted by three of the round electric wires arranged at an outer edge of the three round electric wires constituting the first electric wire group, at such positions that three grooves formed between the three round electric wires of the first electric wire group are blocked, a third electric wire group constituted by six of the round electric wires arranged at an outer edge of the six round electric wires constituting the first electric wire group and the second electric wire group, at such positions that six grooves formed between the six round electric wires of the first electric wire group and the second electric wire group are blocked, and a fourth electric wire group constituted by six of the round electric wires arranged at an outer edge of the nine round electric wires constituting the second electric wire group and the third electric wire group, at such positions that six grooves formed between the nine round electric wires of the second electric wire group and the third electric wire group are blocked.

According to the above three embodiments, the round electric wires, the number of which is a multiple of six, can be divided into two or three equal sub-groups of electric wires, each of which is constituted by an equal number of the round electric wires. Therefore, if the wire harness according to the first embodiment is adopted for a power line of a three-phase motor or a two-phase high-voltage battery, no extra round electric wires are present, and the number of the round electric wires constituting power lines in each phase is equalized. Moreover, as described below, the bundle of the round electric wires, the number of which is a multiple of six, has a small void ratio and superior heat radiating properties compared with the bundle of the two or three round electric wires. Accordingly, with the first embodiment, the very versatile round electric wires can be used to constitute a two-phase or three-phase power line that has superior heat radiating properties without requiring extra wires.

Especially, according to the second embodiment, since the electric wire bundle is constituted by twelve round electric wires, the number of the man-hours for processing the round electric wires is low, even among multiples of six round electric wires. Furthermore, if the electric wire bundle is constituted by twelve round electric wires, the value of the void ratio is relatively small. Accordingly, the wire harness is well-balanced between enhancing the heat radiating properties and reducing the man-hours for processing the round electric wires.

Especially, according to the third embodiment, since the electric wire bundle is constituted by eighteen round electric wires, the number of man-hours for processing the round electric wires is relatively low, and the value of the void ratio is relatively small. Moreover, since the value of an electric current flowing through each of the round electric wires can be reduced or suppressed compared with the case where the number of the round electric wires is twelve, it is possible to reduce or suppress a rise in temperature of the round electric wires.

### BRIEF DESCRIPTION OF THE DRAWINGS

FIG. 1 is a top view of a wire harness 1 according to an embodiment of the present invention.

FIG. 2 is a cross-sectional view of the wire harness 1.

FIG. 3 is a graph showing the relation between the number of round electric wires 10 constituting an electric wire bundle and the void ratio.

FIG. 4 is a cross-sectional view of a wire harness 1b.

### DETAILED DESCRIPTION OF THE EMBODIMENTS

Hereinafter, embodiments of the present invention will be described with reference to the accompanying drawings. The following embodiments are merely examples for working the invention, and are not meant to limit the technical scope of the invention.

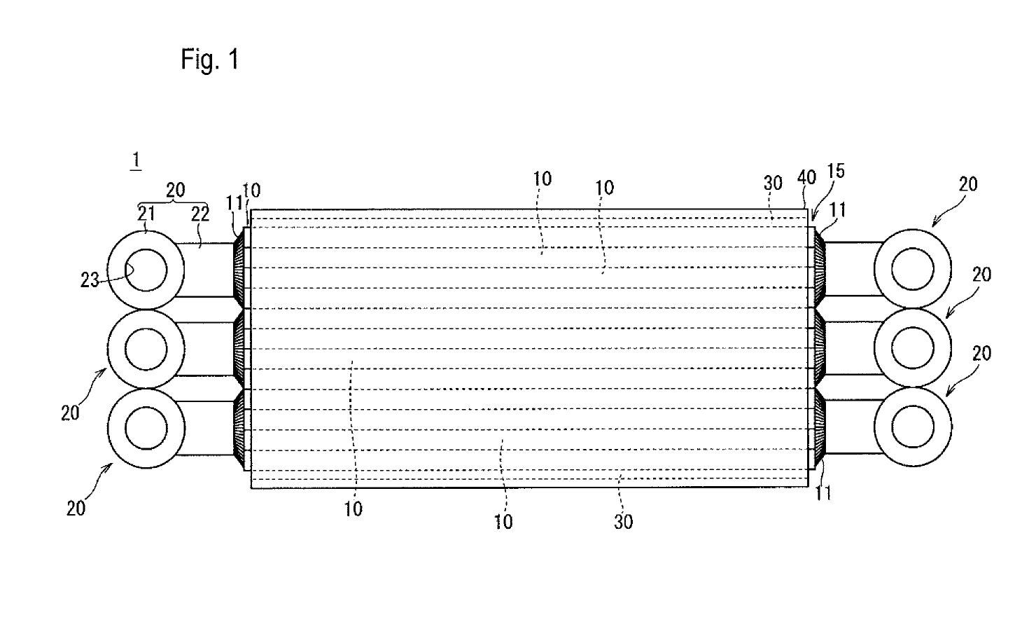

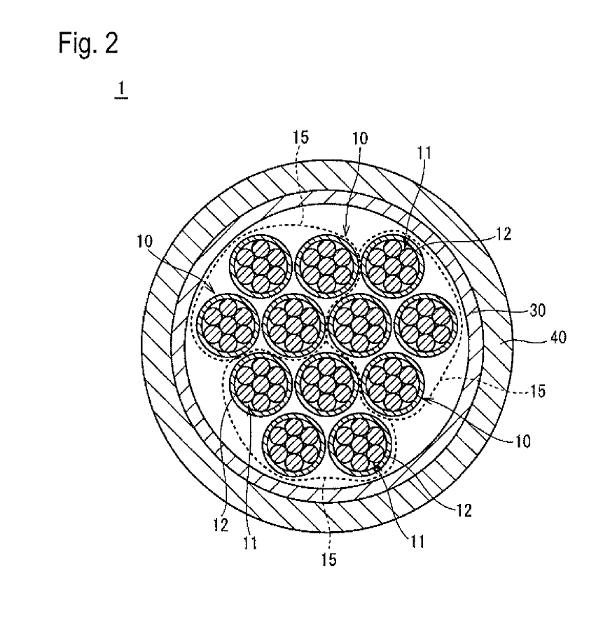

FIG. 1 is a schematic view of a wire harness 1 according to an embodiment of the invention. To facilitate understanding the constitution, the electric wires 10 are arranged in parallel in FIG. 1, but they are not necessarily in that form. The electric wires 10 are arranged as shown in the cross-sectional view in FIG. 2.

The wire harness 1 shown in FIG. 1 includes electric wires 10, crimp terminals 20, a shield member 30, and a corrugated tube 40.

The electric wires 10 each have core wires 11 obtained by tying a plurality of elemental wires serving as a linear conductor in a bundle, and an insulation coating 12 constituted by an insulator covering the periphery of the core wires 11. The core wires 11 and the insulation coatings 12 of the electric wires 10 have a round shape (which may be referred to as “round electric wire 10” hereinafter). The insulation coatings 12 are removed over a predetermined length at the end of the round electric wires 10 to which the crimp terminals 20 are attached. In other words, the electric wires 10 are processed such that the core wires 11 are bare at their ends, and the core wires 11 extend from the end of the insulation coatings 12. The insulation coatings 12 at the end of the electric wires 10 are removed using a wire stripper. An insulation film constituted by enamel may cover the core wires 11 instead of the insulation coating 12.

The crimp terminals 20 each include an attaching portion 21 and a core wire connection portion 22. The attaching portion 21 is a portion attached to an electric device to which the wire harness 1 is connected. The wire harness 1 is connected to the electric device, for example, by fastening a bolt screw or the like to the electric device through a bolt hole 23 provided in the attaching portion 21.

The core wire connection portion 22 is a portion connected to the core wires 11 at the end of the round electric wire 10. The core wire connection portion 22 is crimped in a state in which the core wires 11 are inserted in the core wire connection portion 22. Thereby, the crimp terminal 20 is fixed to and electrically connected to the round electric wire 10.

The shield member 30 is, for example, a braided wire having a structure in which a linear metal bundle obtained by twisting tinned copper wires is braided, or a metal foil formed of copper, aluminum or the like. The braided wire has elasticity resulting from the braided structure, and covers the periphery of the round electric wires 10 in a state of close contact to the round electric wires 10 with its contraction. The wire harness may not necessarily include the shield member 30.

The corrugated tube 40 is a tubular exterior member that covers the round electric wires 10 or the shield member 30 covering the periphery of the round electric wires 10. The corrugated tube 40 is an electric wire protector having a bellows shape in which recesses and salients (not shown) are arranged alternately and continuously along the extending direction of the round electric wires 10 covered with the corrugated tube 40. The corrugated tube 40 is an example of a flexible exterior member.

In the present embodiment, an electric wire bundle constituted by twelve round electric wires 10 tied in a bundle is disposed within the shield member 30, the periphery of which is covered with the corrugated tube 40. In this electric wire bundle, each of a plurality of the round electric wires 10 obtained by being divided into equal parts is electrically independent. Hereinafter, such a plurality of the round electric wires 10 obtained by being divided into equal parts may be referred to as “sub-group 15 of electric wires”.

In the present embodiment, the wire harness 1 includes the three sub-groups 15 of electric wires, each of which is constituted by four round electric wires 10. These sub-groups 15 of electric wires are assigned to respective phases of a three-phase power line, so that the wire harness 1 is used as a three-phase power line.

FIG. 2 is a cross-sectional view of the wire harness 1 according to the embodiment of the invention. A plurality of the round electric wires 10 is tied in a bundle, and thus is arranged as shown in FIG. 2. The electric wire bundle constituted by the twelve round electric wires 10 has a structure including a first electric wire group, a second electric wire group, and a third electric wire group.

The first electric wire group has a structure in which three round electric wires 10 are tied in a bundle such that each of the three round electric wires 10 is adjacent to the other two round electric wires 10. A groove is formed between each of these three round electric wires 10 constituting the first electric wire group and the adjacent round electric wire 10 at the outer edge. In other words, three grooves are formed in the first electric wire group. Next, the three round electric wires 10 constituting the second electric wire group are arranged at such positions that each of these three grooves is blocked. Moreover, six round electric wires 10 constituting the third electric wire group are arranged in the six grooves formed at the outer edge of the six round electric wires 10 constituting the first electric wire group and the second electric wire group. More specifically, the six grooves are formed between the round electric wires 10 constituting the first electric wire group and the round electric wires 10 constituting the second electric wire group which are adjacent to each other. The six round electric wires 10 constituting the third electric wire group are arranged at such positions that each of these grooves is blocked.

Such an arrangement of the round electric wires 10 is easily achieved by tying the round electric wires 10 in a bundle. Furthermore, the area of the minimum circumcircle at the outer edge of the electric wire bundle in the arrangement constitution described above is the smallest of the arrangements that may be assumed by the twelve round electric wires 10.

There is no relation between the round electric wires 10 constituting the first electric wire group, the second electric wire group and the third electric wire group, and the round electric wires 10 constituting the sub-groups 15 of electric wires. The round electric wires 10 constituting the respective sub-groups 15 of electric wires are selected at random from the plurality of round electric wires 10 constituting the electric wire bundle.

In the present embodiment, since the wire harness 1 is used as a three-phase power line, the three crimp terminals 20 are attached to the respective ends of the three sub-groups 15 of electric wires at both ends of the wire harness 1.

The wire harness 1 is not necessarily used for a three-phase power line. The wire harness 1 also can be adopted for a two-phase power line. If the wire harness 1 is adopted for a two-phase power line, each of the sub-groups 15 of electric wires assigned to one of the phases is constituted by six round electric wires 10. The electric wire bundle constituting the wire harness 1 is constituted by the twelve round electric wires 10, and therefore the round electric wires 10 constituting the various sub-groups 15 of electric wires can be divided into equal parts regardless whether the wire harness 1 is adopted for a two-phase or for a three-phase power line.

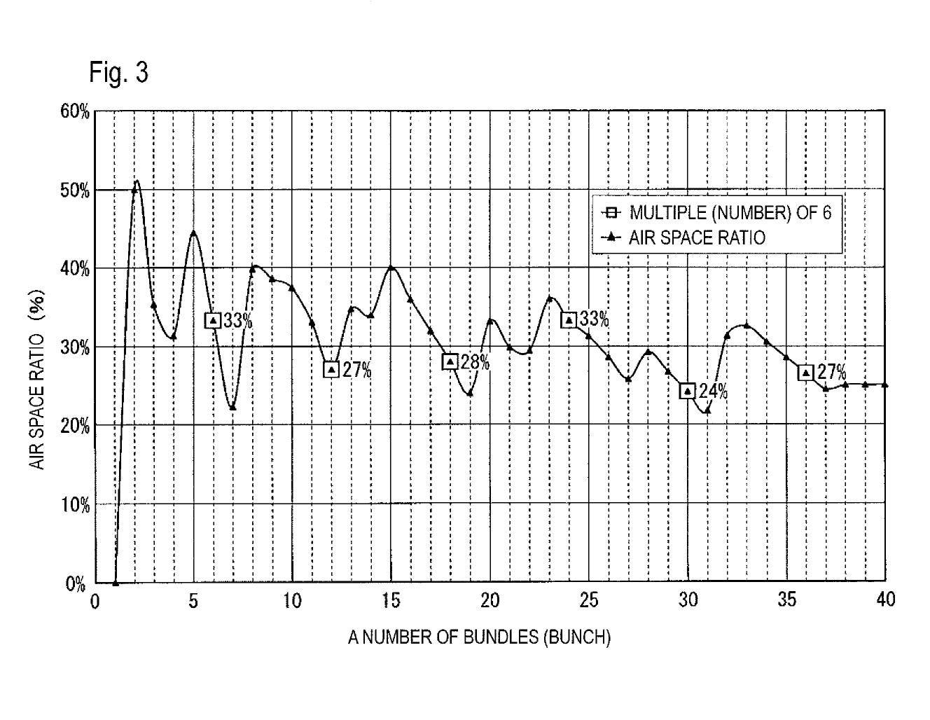

FIG. 3 shows the relation between the number of the round electric wires 10 constituting the wire harness 1 and the void ratio of the wire harness 1 at that time. The void ratio is the ratio of the cross-sectional area of the minimum circumcircle of the plurality of round electric wires 10 to the difference obtained by subtracting the cross-sectional area of the round electric wires 10 from the cross-sectional area of the minimum circumcircle of the plurality of round electric wires 10. In other words, the void ratio is the proportion taken up by air layers present between the round electric wires 10, between the outer edges of the round electric wires 10 and the shield member 30, and between the shield member 30 and the corrugated tube 40 within the corrugated tube 40. In the present embodiment, the void ratio is affected especially by air layers formed between the round electric wires 10, and between the round electric wires 10 and the shield member 30. The void ratio is the proportion taken up by air layers formed between the round electric wires 10, and between the outer edges of the round electric wires 10 and the corrugated tube 40 within the corrugated tube 40 if the wire harness 1 has no shield member 30.

If a wire harness in which a single round electric wire 10 is assigned to each phase is used as a three-phase power line, the electric wire bundle included in the wire harness is constituted by three round electric wires 10. In this case, the void ratio is 35% as shown in FIG. 3. Furthermore, similarly, if a wire harness in which a single round electric wire 10 is assigned to each phase is used as a two-phase power line, the electric wire bundle included in the wire harness is constituted by two round electric wires 10. In this case, the void ratio is 50% as shown in FIG. 3. On the other hand, if the electric wire bundle included in the wire harness 1 is constituted by twelve round electric wires 10 and four round electric wires 10 are assigned to each phase as in the present embodiment, the void ratio is 27% as shown in FIG. 3. Thus, the void ratio of the electric wire bundle constituted by twelve round electric wires 10 is smaller than that of an electric wire bundle constituted by two or three round electric wires 10.

Heat generated in the round electric wires 10 is first transmitted to the shield member 30, then to the corrugated tube 40, and is radiated from the outer peripheral surface of the corrugated tube 40. Generally, air transmits heat less easily than material objects. Therefore, in the cross-section of the wire harness 1, as the ratio of the air layers formed between the round electric wires 10, and between the outer edge of the electric wire bundle and the shield member 30 decreases, heat generated in the round electric wires 10 is transmitted more easily to the shield member 30. In other words, as the void ratio decreases, heat is transmitted more easily to the outer peripheral surface of the corrugated tube 40, and therefore the wire harness 1 has superior heat radiating properties.

Furthermore, since the number of the round electric wires 10 constituting the electric wire bundle is twelve, the number of the round electric wires 10 constituting each of the sub-groups 15 of electric wires is the same regardless whether the wire harness 1 is adopted for a two-phase power line or for a three-phase power line. Accordingly, no extra electric wires are present in the respective phases of the wire harness 1. In other words, the wire harness 1 is applicable to both a two-phase power line and a three-phase power line.

The effect described above is not limited to the case where the number of the round electric wires 10 constituting the electric wire bundle is twelve, but is obtained when this number is a multiple of six. Accordingly, the wire harness according to the embodiment of the invention may have an electric wire bundle constituted by the round electric wires 10, whose number is a multiple of six. Especially, as the number of round electric wires 10 constituting the electric wire bundle increases, the void ratio of the wire harness decreases (see FIG. 3), and therefore the heat radiating properties of the wire harness are enhanced.

However, as the number of the round electric wires 10 constituting the electric wire bundle increases, the number of man-hours for processing which the round electric wires 10 must undergo increases. Specifically, examples of processing include adjustment in length and wire stripping of the round electric wires 10. Accordingly, among the electric wire bundles constituted by the round electric wires 10 whose number is a multiple of six, it is effective to configure the electric wire bundle from twelve round electric wires 10 in which case the number of man-hours for processing the round electric wires 10 is relatively low and the void ratio is relatively small. In other words, if the number of the round electric wires 10 constituting the electric wire bundle is twelve, the wire harness 1 achieves an excellent balance of improving the heat radiating properties and reducing the man-hours for processing.

As described above, the wire harness 1 according to the embodiment of the invention has a structure in which the tubular corrugated tube 40 that is an exterior member covers the periphery of the electric wire bundle constituted by the round electric wires 10, the number of which is a multiple of six, and a crimp terminal 20 is attached to each of the sub-groups 15 of electric wires obtained by dividing the electric wire bundle into equal parts, each containing a plurality of the round electric wires 10.

Accordingly, each of the sub-groups 15 of electric wires obtained by dividing the electric wire bundle into equal parts can be assigned to a respective phase regardless whether the wire harness 1 is used for a two-phase or for a three-phase power line. Therefore, no extra electric wires are present in securing the cross-sectional area of the electric wires required for each phase. Furthermore, the wire harness 1 can be used for both a two-phase power line and a three-phase power line.

Furthermore, the wire harness 1 has an electric wire bundle constituted by a plurality of the round electric wires 10, the number of which is a multiple of six. Therefore, while adopting the very versatile round electric wires 10, it is possible to reduce the value of the void ratio within the wire harness 1. In other words, while using the very versatile round electric wires 10 for the wire harness 1, it is possible to enhance the heat radiating properties of the wire harness 1.

Especially, if the wire harness 1 has an electric wire bundle constituted by twelve round electric wires 10, a wire harness 1 is obtained that is well-balanced between improving the heat radiating properties and reducing the man-hours for processing the round electric wires 10.

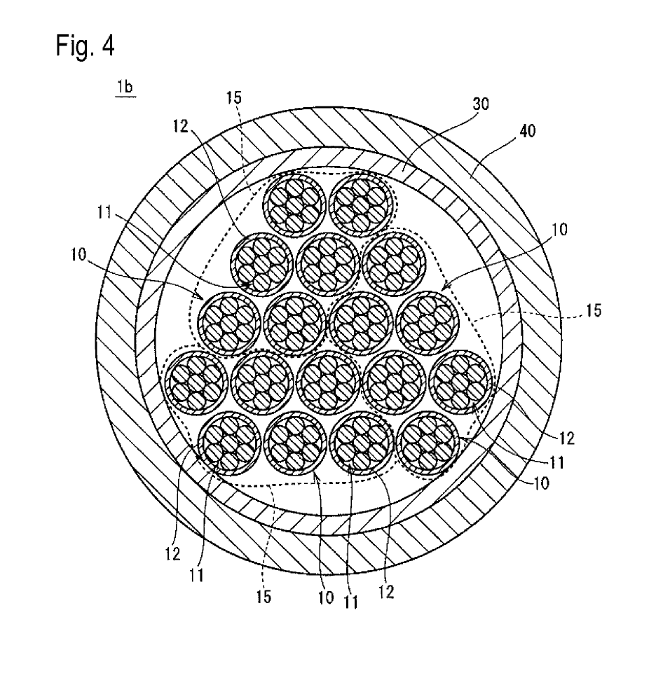

It is also effective if the number of the round electric wires 10 constituting the electric wire bundle is eighteen. FIG. 4 shows an arrangement of the round electric wires 10 in the cross-section of a wire harness lb including eighteen round electric wires 10. The eighteen round electric wires 10 are tied in a bundle, and therefore are arranged as shown in FIG. 4.

Specifically, the electric wire bundle constituted by the eighteen round electric wires 10 includes a first electric wire group, a second electric wire group, a third electric wire group and a fourth electric wire group.

The first electric wire group has a structure in which three round electric wires 10 are tied in a bundle such that each of the three round electric wires 10 is adjacent to the other two round electric wires 10. A groove is formed between each of these three round electric wires 10 constituting the first electric wire group and the adjacent round electric wire 10 at the outer edge.

Next, three round electric wires 10 are arranged at such positions that each of the three grooves formed by the first electric wire group is blocked. Thus, the three round electric wires 10 arranged at the outer edge of the first electric wire group correspond to the second electric wire group.

Next, six round electric wires 10 are arranged at the six grooves formed at the outer edge of the six round electric wires 10 constituting the first electric wire group and the second electric wire group. Specifically, the six grooves are formed between round electric wires 10 constituting the first electric wire group and round electric wires 10 constituting the second electric wire group which are adjacent to each other. The six round electric wires 10 are then arranged at such positions that each of these grooves is blocked. The six round electric wires 10 arranged at the outer edge of the round electric wires 10 constituting these first electric wire group and second electric wire group correspond to the third electric wire group.

Moreover, the six round electric wires 10 corresponding to the fourth electric wire group are respectively arranged at the grooves formed at the outer edge of the second electric wire group and the third electric wire group. Specifically, the six round electric wires 10 are arranged at the six grooves formed between round electric wires 10 constituting the second electric wire group and round electric wires 10 constituting the third electric wire group that are adjacent to each other so as to block those grooves.

Such an arrangement of the round electric wires 10 is easily achieved by tying the round electric wires 10 in a bundle. Furthermore, the minimum circumcircle based on the arrangement constitution described above is the smallest of the minimum circumcircles based on the arrangements that the eighteen round electric wires 10 may have.

If the number of the round electric wires 10 constituting the electric wire bundle is eighteen, the value of the void ratio is 28% as shown in FIG. 3. Namely, the value of the void ratio in the case where the number of the round electric wires 10 constituting the electric wire bundle is eighteen is nearly the same as that in the case where the number of the round electric wires 10 constituting the electric wire bundle is twelve. Therefore, nearly the same heat radiating properties are obtained in the wire harness lb as with the wire harness 1. Furthermore, the number of man-hours for processing the round electric wires 10 is relatively low. Moreover, if the number of the round electric wires 10 constituting the electric wire bundle is eighteen, the value of the electric current flowing through each of the round electric wires 10 becomes smaller than if the number of the round electric wires 10 constituting the electric wire bundle is twelve. Therefore, it is possible to further reduce or suppress a rise in temperature of the round electric wires 10.

1. A wire harness, comprising:
an electric wire bundle including a multiple of six of the round electric wires covered with an insulation coating tied in a bundle;
a plurality of terminals provided at both ends of each of a plurality of sub-groups of the electric wires, the sub-groups of the electric wires being units obtained by dividing the electric wire bundle into equal parts, each unit including a plurality of the round electric wires; and
a tubular exterior member which covers a periphery of the electric wire bundle.

2. The wire harness according to claim 1, wherein the electric wire bundle includes:
twelve of the round electric wire;
a first electric wire group constituted by three of the round electric wires tied in a bundle such that each of the three round electric wires contacts the adjacent two round electric wires;
a second electric wire group constituted by three of the round electric wires arranged at an outer edge of the three round electric wires constituting the first electric wire group, at such positions that three grooves formed between the three round electric wires of the first electric wire group are blocked; and
a third electric wire group constituted by six of the round electric wires arranged at an outer edge of the six round electric wires constituting the first electric wire group and the second electric wire group, at such positions that six grooves formed between the six round electric wires of the first electric wire group and the second electric wire group are blocked.

3. The wire harness according to claim 1, wherein the electric wire bundle includes:
eighteen of the round electric wires;
a first electric wire group constituted by three of the round electric wires tied in a bundle such that each of the three round electric wires contacts the adjacent two round electric wires;
a second electric wire group constituted by three of the round electric wires arranged at an outer edge of the three round electric wires constituting the first electric wire group, at such positions that three grooves formed between the three round electric wires of the first electric wire group are blocked;
a third electric wire group constituted by six of the round electric wires arranged at an outer edge of the six round electric wires constituting the first electric wire group and the second electric wire group, at such positions that six grooves formed between the six round electric wires of the first electric wire group and the second electric wire group are blocked; and
a fourth electric wire group constituted by six of the round electric wires arranged at an outer edge of the nine round electric wires constituting the second electric wire group and the third electric wire group, at such positions that six grooves formed between the nine round electric wires of the second electric wire group and the third electric wire group are blocked.

4. The wire harness according to claim 1, wherein each of the elastic wires includes seven core wires that are together surrounded by the insulation coating.

5. The wire harness according to claim 1, further including a shield member surrounding the electric wire bundle and disposed within the tubular exterior member.

6. The wire harness according to claim 5, wherein the shield member includes a structure in which a linear metal bundle obtained by twisting tinned copper wires is braided, or a metal foil formed of copper or aluminum.

7. The wire harness according to claim 6, wherein the tubular exterior member is a corrugated tube having a bellows shape in which recesses and salients are arranged alternately and continuously along an extending direction of the round electric wires.

8. The wire harness according to claim 4, wherein the terminals are crimp terminals that each include an attaching portion and a core wire connection portion, the attaching portion being attached to an electric device to which the wire harness is attached.

9. The wire harness according to claim 8, wherein the core wire connection portion is configured to be crimped while the core wires are disposed therein.
